(19) United States
(12) Patent Application Publication
(10) Pub. No.: US 2026/0348701 A1
(43) Pub. Date: Nov. 5, 2026

(54) SYSTEM AND METHOD FOR PROVIDING ASSISTED SHOOTING

(71) Applicant: KONGSBERG DEFENCE & AEROSPACE AS, KONGSBERG (NO)

(72) Inventors: Lars Egil BJØRSET, Kongsberg (NO); Pål Longva HELLUM, Blommenholm (NO)

(21) Appl. No.: 19/196,472

(22) Filed: May 1, 2025

(51) Int. Cl. F41G 3/16; F41G 3/22

(52) U.S. Cl. CPC F41G 3/165; F41G 3/22

(57) ABSTRACT

A method and system for precise controlling and firing an unmanned weapon at a selected target observed in video streamed with a reduced framerate to a remote location via a wireless network. The method includes capturing high-quality video of a selected field of view at the weapon at a first location. A target tracker is tracking a selected target in the high-quality video. Compressed video with reduced quality is streamed to an operator position at a second location. When the operator selects and confirms a valid target, the unmanned weapon system fires if the hit probability is above a threshold. The system includes devices and units for performing the method.

### TECHNICAL FIELD

The invention relates to a weapon system, and more specifically to an unmanned weapon system wherein video from one location at the weapon is streamed wirelessly to an operator controlling the weapon from another location.

### BACKGROUND

Wireless networks and Robotic Combat Vehicles (RCV) are becoming increasingly important in conflicts and warfare. The frontlines in combat zones are becoming a battle of unmanned assets like Unmanned ground Vehicle (UGV), Unmanned Surface Vehicle (USV) and Unmanned Aerial Vehicles (UAV). The possibility to effectively operate these assets in a safe manner is critical, as well as providing robust, precise and effective engagements.

When controlling RCV's via a wireless network, time delay in the form of latency is inevitably introduced. In addition to latency and latency variations, wireless networks also have bandwidth limitations. This means that events at a location of an RCV, captured by a camera in real-time and streamed via a wireless video link, will be presented to an operator with some time lag, i.e. slightly after an incident has occurred. Due to bandwidth limitations, the streamed video may also have lower video quality than the captured video.

Latency in a signal chain reduces the possibility to control a weapon system precisely and effectively in real-time in a closed loop control system. In a closed loop control system, video from the location of the weapon system is captured by a camera and distributed via a signal chain to an operator. The operator acts on the video, for instance through a control grip, and a servo system at the weapon responds to the control, e.g. by initiating firing at the target, and the video is updated. The latency in the system will however result in a less responsive system with a corresponding lack of operator precision. This means that a target identified on video streamed to the operator may have moved significantly from an identified position before shots are fired at the target.

Bandwidth limitations in wireless networks may limit the possibility to distribute high quality and high frequency video to the operator. Increased bandwidth requirements will reduce the robustness of the communication solution against jamming and may also provide poor geographical coverage. Some solutions like satellite links may improve available bandwidth, but at the expense of latency.

Operating current unmanned weapon systems by radio communication involves transferring of video signals over a bandwidth limited radio interface and operator control of the weapon system with an engagement where the operator attempts to hit the target. Due to latency, it may be hard to hit a moving target. Some systems may have a target tracker to reduce the effect of latency over the radio.

To reduce the negative effects of latency and bandwidth restrictions, it is desirable to remove the dependency of precision control from the operator to the weapon system and solve as many aspects as possible of the closed loop control system locally at the unmanned weapon rather than remotely over the radio communication without sacrificing required security.

The present invention addresses said shortcomings by providing a robust, precise, and safe solution for controlling an unmanned weapon system with man-in-the-loop and man-on-the-loop.

### SUMMARY OF THE INVENTION

Precise and secure controlling of an unmanned weapon via a wireless network is challenging due to latency and bandwidth restrictions of the wireless network used.

The present invention discloses a method and system for precise controlling and firing an unmanned weapon at a selected target observed in video streamed with a reduced framerate to a remote location via a wireless network.

According to one aspect, the invention is a method comprising several steps.

The first step is capturing video with a camera of a selected field of view at the unmanned weapon located at a first location.

The next step is activating a video target tracker connected to the camera and tracking a selected target within the field of view and aligning Line of Sight (LOS) of the camera with the target tracker. This means that the focus point of the camera is directed at the target.

The next step is processing captured video and streaming the processed video via the wireless network to a display and control unit at a second location.

The next step is confirming a valid tracked target by an operator at the second location inspecting the target displayed.

According to one aspect, high-definition and high framerate video is captured with a camera, installed on the unmanned weapon system, and streamed as lower framerate video via the wireless network to the operator.

According to one aspect, the framerate of the captured video is reduced, and video is compressed according to available bandwidth of the wireless network before streaming the video to the second location.

According to one aspect, the streamed video received at the second location is decompressed before being displayed on the display unit.

According to one embodiment, the field of view and target to be tracked are automatically selected by a surveillance system at the first position. In one aspect, the surveillance system comprises one or more of radars, optical sensors and acoustic sensors used for automatically selecting the field of view and target to be tracked.

According to one embodiment, the target automatically selected by the surveillance system is displayed on the display unit at the second location. The operator can then confirm if it is a true target.

According to another embodiment, the field of view and target to be tracked are manually selected by the operator at the second location. In one aspect, this may be done by using one or more sensors among radars, optical sensors and acoustic sensors. Possible targets detected by the sensors may be presented on the display unit for the operator, who then can select a target to be tracked.

The next step of the method is aligning a Line of Bore (LOB) of the unmanned weapon with the LOS of the camera tracking the confirmed target, while also adjusting the LOB according to ballistic trajectory of effector used.

Ballistic trajectory of an effector is determined by factors such as distance to target, type of effector used and external factors such as wind, temperature and humidity. Distance from the LOB to the target can be determined based on inputs from radar, Laser Range Finder, manual range input or cross targeting between multiple sensors.

When a tracked target has been confirmed by an operator to be a valid target, and the LOB of the unmanned weapon has been correlated with the LOS of the camera tracking the confirmed target, the next step is arming the unmanned weapon. Arming is performed by sending an arming control signal via the wireless network from the second location to the weapon at the first location, when an operator activates a trigger mechanism.

When the unmanned weapon has been armed, firing of the weapon is activated by transmitting a fire activation signal from the second location to a fire activation device of the weapon at the first location. The activation signal is transmitted while an operator activates a trigger mechanism.

In one embodiment, the fire activation signal is activated when the operator at the second location activates a trigger mechanism, for instance by pressing and holding a trigger button on a joystick or pressing and holding a separate push button.

The next step of the method is calculating a hit probability of hitting the confirmed target while the fire activation signal is received from the second location. The calculation is performed in a calculation device at the first location.

In one embodiment, the hit probability is calculated based on one or more of the following: alignment of LOS with tracker position, alignment of Line of Sight with Line of Bore adjusted for ballistics trajectory, consistent Line of Sight tracking of target, tracker position and motion pattern of the target correlated with time of flight of effector used and visual analysis of the target to be engaged to predict target motion.

In one embodiment of the method, object detection data comprising positions of objects and object class are integrated in the streamed video displayed on the display unit at the second location.

The last step of the method is firing the unmanned weapon if armed, and the fire activation signal is received and if a hit probability is above a set threshold.

Based on the method steps described above, the unmanned weapon will only be fired when an operator confirms a valid tracked target, thereby arming the weapon, activates a trigger signal, and when a hit probability for hitting a target is above a set threshold value.

According to another aspect, the invention comprises a system for precise controlling and firing an unmanned weapon at a selected target observed in video streamed with a reduced framerate to a remote location via a wireless network.

At a first location, the system comprises an unmanned weapon connected to a Line of Bore (LOB) controller and a camera connected to a video target tracker which is connected to a Line of Sight (LOS) controller of the camera,

A video processing and streaming device, connected to the camera, is configured for compressing and streaming video via the wireless network to a second location.

At a second location, the system comprises a video decompression device connected to the wireless network and a display and control unit, a transmitter connected to the display and control unit and the wireless network, which is configured for receiving instructions from an operator of the display and control unit and transmitting control signals via the wireless network to a fire activation device connected to the unmanned weapon.

A firing controller, connected to the unmanned weapon, comprising a calculation device connected to the LOB controller and the LOS controller, the calculation device is configured to calculate a probability of hitting the target, wherein the firing controller is configured to fire the weapon when the hit probability is above a set threshold and a fire activation signal is received from the fire activation device via the wireless network.

In one embodiment, the LOB controller comprises data describing ballistics of effectors used.

### SHORT DESCRIPTION OF THE FIGURES

The present invention will be explained in detail by reference to an example embodiment shown in the figures, in which:

FIG. 1 illustrates the overall concept of a weapon system controlled from an operator position via a wireless communications network.

FIG. 2 illustrates the different components and units comprised in the system.

FIG. 3 is a flowchart showing the steps performed for providing assisted firing of an unmanned weapon via a wireless network.

### DETAILED DESCRIPTION OF THE INVENTION

As described, the present invention addresses the need for a method and system reducing shortcomings and negative effects of latency and bandwidth restrictions when controlling a weapon system over a wireless network.

The invention addresses said shortcomings by providing a robust, precise and effective solution for controlling a weapon system with man-in-the-loop and man-on-the-loop.

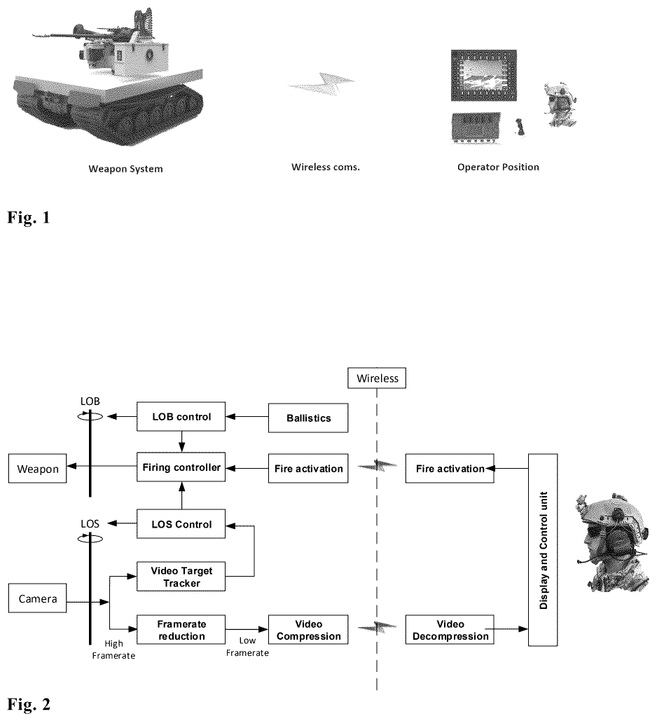

FIG. 1 illustrates the overall concept of a weapon system controlled from an operator position via a wireless network. In this example, an Unmanned ground Vehicle (UGV) is used to carry the weapon system. The invention is however not restricted to this type of UGVs. The solution will apply to all types of wirelessly controlled weapon systems controlled by an operator via a display unit, where latency introduced in system introduces a restriction for real-time precise and secure control.

FIG. 2 illustrates the different components comprised in the system for secure controlling of an unmanned weapon via a wireless network. The unmanned weapon is located at a first location. The Line of Bore (LOB) of the weapon is controlled by a LOB controller connected to suitable driving means for controlling movements of the LOB. A camera is located at the first location. For a responsive and precise system, the camera is preferably a HD camera with high framerate. This will be able to follow relatively small moving objects, such as drones.

The camera may be connected to the unmanned weapon or be separate from this and arranged to capture video of a selected field of view from the unmanned weapon. The camera is connected to a video target tracker which may be an integrated part of the camera.

The video target tracker is connected to a Line of Sight (LOS) controller, controlling the camera to keep LOS at a selected target. The camera is further connected to a video processing device configured to reduce frame rate of captured video as well as compressing the captured video before streaming it via the wireless network to the second position.

At the second location a display and control unit is connected to a video processing device configured for receiving compressed video over the wireless network from the first location. The video processing device is further configured to decompress the compressed streamed video before being displayed for an operator at the second location. From the display and control unit, the operator confirms a displayed target as a valid target and may select a specific target to be tracked if several targets are displayed. When a target is confirmed, an arming signal is transmitted to the unmanned weapon.

The arming signal as well as other control signals are transmitted over the wireless network from a transmitter connected to the display and control unit.

At the first location, a fire activation device is connected to a firing controller of the unmanned weapon controlling firing. An operator can then activate a fire activation signal by pressing a fire activation button at the second location. The button is kept pressed or is released based on observations and continuous assessment of the tracked target in the streamed video displayed.

The firing controller comprises a calculation device connected to the LOB controller and the LOS controller. The calculation device is configured to calculate a probability of hitting the target. The firing controller is configured to fire the weapon when the fire activation signal is received, and the hit probability is above a set threshold.

Ballistics data for the type of effector used may be input into the LOB controller to ensure that the LOB is adjusted for hitting the target. The LOB controller may also receive data related to external factors affecting the ballistics such as wind, temperature, pressure and rainfall.

A hit probability is calculated based on one or more parameters such as alignment of LOS with video target tracker position, alignment of LOS with LOB, consistent LOS tracking of target, e.g. an increase or decrease in alignment of LOS and LOB within a time frame, tracker position movement pattern of the target correlated with time of flight of effector used and visual analysis of the target to be engaged to predict target motion.

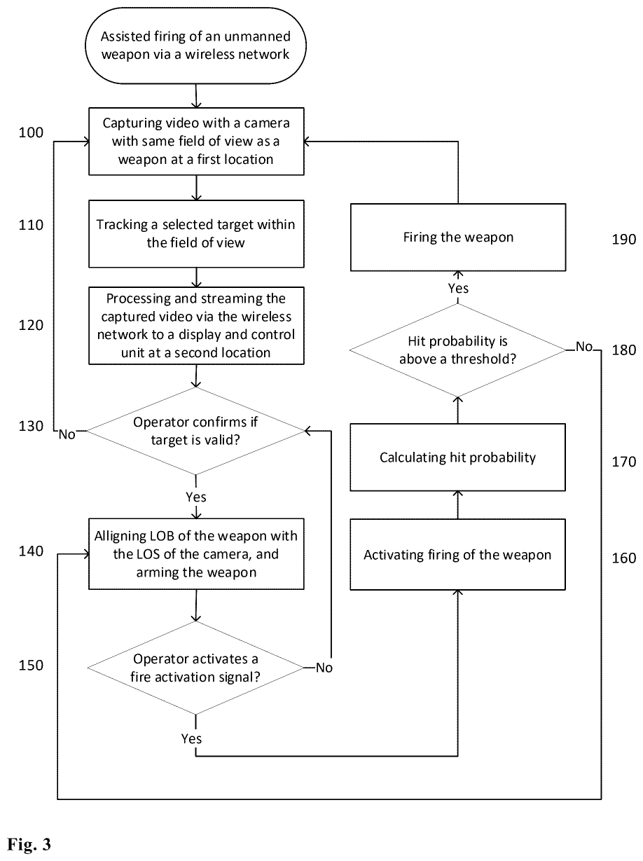

FIG. 3 is a flowchart showing the steps performed for providing assisted firing of an unmanned weapon via a wireless network. The method provides precise and secure controlling and firing the unmanned weapon at a selected target observed in video that is streamed with a reduced framerate to a remote location via the wireless network.

Video is captured 100 with a camera having same field of view as the unmanned weapon at a first location, and that is to be controlled via a wireless network by an operator at a second location, e.g. a location distant from the first location.

A target automatically selected at the first location may be detected by different means such as radars, optical sensors and acoustic sensors registering identifiable sound. When detected, the field of view of the camera is directed at a detected target.

When a target is in the field of view of the camera, a video target tracker is activated to focus on, and track the target 110.

When tracking a target, the Line of Sight (LOS) of the camera is aligned with the video tracker. If the video tracker is an integrated part of the camera, they are already aligned.

The video that is captured is split into two branches at the first location, wherein a first branch is input to the target tracker. This will be unprocessed video, preferably high-resolution video with high frame rate. This means that the LOB of the weapon may be moved instantly to follow movements of a target tracked in the video.

A second branch of the video is fed to the video processing and streaming device preparing the video to be streamed over a wireless network, with possibly reduced bandwidth unsuitable for streaming high quality video produced by the video camera.

In the example illustrated in FIG. 2, the video to be streamed is processed by reducing the framerate of the captured video from high framerate to low framerate prior to compressing the video. The amount of processing of the captured video can be adapted to available bandwidth of the wireless network.

When the second branch of the captured video has been processed, it is streamed 120 over the wireless network from the first location to the second location where an operator is positioned. Streamed video is decompressed and input to a display and control unit controllable by the operator.

A target being tracked by the unmanned weapon system is displayed, and the operator viewing the target on the display either confirms 130 that it is a valid target or select another target to be tracked if several targets are displayed. Video is captured and a target is tracked until the operator confirms a valid target.

When a valid target is confirmed, the LOB of the unmanned weapon is aligned 140 with the LOS of the camera tracking the confirmed target. The Line of Bore is also adjusted according to ballistic trajectory of effector used. When a valid target is confirmed by the operator, an arming (ARM) signal is transmitted over the wireless network to the weapon, thereby arming it.

While continuously confirming a valid target, the operator activates a trigger mechanism by using e.g. a joystick controller, switch or touch screen connected to the display and control unit. A fire activation signal 150 is then transmitted over the wireless network to the fire activation device comprised at the first position. The unmanned weapon is then activated for firing 160.

When the fire activation signal is received by the firing controller of the unmanned weapon system, the calculation unit in the firing controller calculates hit probability 170 of hitting the confirmed target.

Hit probability is calculated based on one or more of the following: alignment of LOS with tracker position, alignment of Line of Sight with Line of Bore adjusted for ballistics trajectory, consistent Line of Sight tracking of target, tracker position and motion pattern of the target correlated with time of flight of effector used and visual analysis of the target to be engaged to predict target motion.

If the hit probability is above a set threshold 180, engagement and firing 190 of the unmanned weapon system is executed. If the hit probability is below the set threshold, it is returned to step 140 of aligning the LOB of the unmanned weapon with the LOS of the camera tracking the confirmed target.

As described, firing of the unmanned weapon is only possible if both ARM and trigger activation signals are present at the unmanned weapon system.

The operator can keep the trigger mechanism activated while continuously monitoring and confirming the target and the surroundings and release the trigger mechanism if there are any changes to the target or situation. Target engagement will immediately be cancelled when the trigger mechanism is released.

1. A method for controlling and firing an unmanned weapon at a selected target observed in a video streamed with a reduced frame rate to a remote location via a wireless network, the method comprising:
capturing the video with a camera of a selected field of view at the unmanned weapon at a first location;
activating a video target tracker connected to the camera and tracking the selected target within the field of view and aligning a line of sight of the camera with the target tracker;
processing the captured video and streaming the processed video via the wireless network to a display and controller system at a second location;
confirming a valid tracked target by an operator at the second location inspecting the displayed target;
aligning a line of bore of the unmanned weapon with the line of sight of the camera tracking the confirmed target, while adjusting the line of bore according to a ballistic trajectory of a used effector;
arming the unmanned weapon, by sending an arming control signal via the wireless network from the second location to the weapon at the first location, when the valid tracked target is confirmed by the operator;
activating firing of the unmanned weapon by transmitting a fire activation signal from the second location to a fire activation device of the weapon at the first location, when the operator activates a trigger mechanism;
calculating, in a calculator at the first location, a hit probability of hitting the confirmed target while the fire activation signal is received from the second location; and
firing the unmanned weapon in a case in which the unmanned weapon is armed, the fire activation signal is received, and the hit probability is above a set threshold.

2. The method according to claim 1, further comprising
capturing high-definition and high frame rate video with the camera installed on the unmanned weapon system; and
streaming compressed video with a lower frame rate video via the wireless network to the operator.

3. The method according to claim 1, further comprising reducing the frame rate of the captured video, and compressing the video according to available bandwidth of the wireless network before streaming the video to the second location.

4. The method according to claim 3, further comprising decompressing the streamed video received at the second location before displaying the streamed video on the display.

5. The method according to claim 1, further comprising automatically selecting, by a surveillance system at the first position, the selected field of view and the target to be tracked.

6. The method according to claim 5, wherein sensors comprising radars, optical sensors and acoustic sensors are configured to automatically select a current field of view and the target to be tracked.

7. The method according to claim 5, further comprising displaying the field of view and the target that is automatically selected by the surveillance system on the display at the second location.

8. The method according to claim 1, further comprising manually selecting, by the operator at the second location, the field of view and the target to be tracked.

9. The method according to claim 8, further comprising manually selecting, using one or more sensors among radars, optical sensors, and acoustic sensors, the field of view and the target to be tracked.

10. The method according to claim 1, further comprising receiving a fire activation signal when the operator presses a trigger mechanism at the second location.

11. The method according to claim 1, further comprising adjusting the line or bore according to a distance to the target, the ballistics of the effector used and external influencing factors.

12. The method according to claim 1, wherein the calculating of the hit probability is based on one or more of the following: an alignment of the line of sight with a tracker position, alignment of the line of sight with the line of bore adjusted for ballistics trajectory, consistent tracking of target using the line of sight, tracker position and motion pattern of the target correlated with time of flight of the used effector, and visual analysis of the target to be engaged to predict motion of the target.

13. The method according to claim 1, wherein object detection data comprising positions of objects and object class are integrated in the streamed video.

14. A system for precise controlling and firing of an unmanned weapon at a selected target observed in video streamed with reduced framerate to a remote location via a wireless network, comprising:
at a first location, an unmanned weapon connected to a line of bore controller and a camera connected to a video target tracker that is connected to a line of sight controller of the camera, and
a video processing and streaming device, connected to the camera, configured for compressing and streaming video via the wireless network to a second location,
at the second location, a video decompression device connected to the wireless network and a display and control system, a transmitter connected to the display and control system and the wireless network, configured for receiving instructions from an operator of the display and control system and transmitting control signals via the wireless network to a fire activation device connected to the unmanned weapon,
a firing controller, connected to the unmanned weapon, comprising a calculation device connected to the line of bore controller and the line of sight controller, the calculation device being configured to calculate a probability of hitting the target, wherein the firing controller is configured to fire the weapon in a case in which the calculated probability of hitting the target is above a set threshold and a fire activation signal is received from the fire activation device via the wireless network.

15. The system according to claim 14, wherein the line of bore controller comprises data describing ballistics of effectors used.
